(19) United States
(12) Patent Application Publication
(10) Pub. No.: US 2026/0039980 A1
(43) Pub. Date: Feb. 5, 2026

(54) System and Method for Dynamically Routing Call Data Between Client Devices and Public Branch Exchange Systems

(71) Applicant: ZEBRA TECHNOLOGIES CORPORATION, Lincolnshire, IL (US)

(72) Inventors: David Kreider, Elk River, MN (US); Win Nu Nu Win, Palatine, IL (US); Iouri Tarsounov, Lakewood Ranch, FL (US); Vladyslav Koval, Orlando, FL (US); Amit Shah, Hoffman Estates, IL (US)

(21) Appl. No.: 18/791,318

(22) Filed: Jul. 31, 2024

(51) Int. Cl. H04Q 3/62; H04L 65/1053; H04L 65/1104

(52) U.S. Cl. CPC H04Q 3/625; H04L 65/1053; H04L 65/1104; H04Q 2213/1322

(57) ABSTRACT

A communication server system may one or more processors and one or more non-transitory, computer-readable media storing instructions that, when executed by the one or more processors, cause the communication server system to detect a call event relating to a telephone network identifier. The system may dynamically link one or more active client accounts to a reservable private branch exchange (PBX) system identifier based on first details of the call event and second details of the one or more active client accounts. The PBX system may employ a session initiation protocol (SIP). The system may route call data between one or more devices associated with the active client accounts dynamically linked to the reservable PBX system identifier and a user device associated with the telephone network identifier.

### BACKGROUND

The Web Real-Time Communication (WebRTC) protocol provides a powerful, flexible, and cost-effective solution for incorporating real-time communication capabilities into applications (e.g., web applications, mobile applications, etc.) without the need for added plugins or software. In addition to being operating system and browser agnostic, the WebRTC protocol also provides benefits including low latency, built-in security features (e.g., end-to-end encryption), and support for audio, video, and data transmissions, among other advantages. However, current systems that employ the WebRTC platform or other web-based communication platforms do not include integration with existing telephone networks such as private branch exchange (PBX) systems that utilize session initiation protocol (SIP) trunks and/or the public switched telephone network (PSTN). Furthermore, to the extent these existing systems do provide integration with the PSTN or existing customer PBX systems, each individual user of the system is assigned a unique telephone network identifier, which can be a costly expense and complicated to manage infrastructure for companies with varying staffing levels and/or frequent staffing turnover.

Accordingly, there is a need for systems and methods that provide integration between web based communication systems and existing PBX systems and/or the PSTN.

### SUMMARY

In some aspects, the techniques described herein relate to a communication server system including: one or more processors; and one or more non-transitory, computer-readable media storing instructions that, when executed by the one or more processors, cause the communication server system to: detect a call event relating to a telephone network identifier; dynamically link one or more active client accounts to a reservable private branch exchange (PBX) system identifier based on first details of the call event and second details of the one or more active client accounts, the PBX system employing a session initiation protocol (SIP); and route call data between one or more devices associated with the active client accounts dynamically linked to the reservable PBX system identifier and a user device associated with the telephone network identifier.

In some aspects, the techniques described herein relate to a communication server system wherein when the call event includes an incoming call from the telephone network identifier, execution of the instructions further cause the communication server system to: receive the first details of the call event as part of the incoming call; identify the reservable PBX system identifier from the first details of the call event; retrieve a set of potential client accounts that are associated with the reservable PBX system identifier in a database; and select the one or more active client accounts from the set of potential client accounts.

In some aspects, the techniques described herein relate to a communication server system wherein execution of the instructions further cause the communication server system to: select the one or more active client accounts from the set of potential client accounts by identifying which ones of the set of potential client accounts are associated with currently active users.

In some aspects, the techniques described herein relate to a communication server system wherein the first details of the call event that identify the reservable PBX system identifier include a telephone extension number.

In some aspects, the techniques described herein relate to a communication server system wherein the first details of the call event that identify the reservable PBX system identifier include a selection from a telephone menu system.

In some aspects, the techniques described herein relate to a communication server system wherein when the call event includes an outgoing call to the telephone network identifier, execution of the instructions further cause the communication server system to: receive the first details of the call event as part of the outgoing call; identify the one or more active client accounts from the first details of the call event identify a site assignment for the one or more active client accounts; and identify the reservable PBX system identifier from a list of available telephone network identifiers based on the site assignment.

In some aspects, the techniques described herein relate to a communication server system wherein execution of the instructions further cause the communication server system to: search all SIP trunks of the PBX system that are associated with the site assignment and a parent region of the site assignment for the list of available telephone network identifiers; select the reservable PBX system identifier as a first available identifier identified from the SIP trunks that are associated with the site assignment; and select the reservable PBX system identifier as a first available identifier identified from the SIP trunks that are associated with the parent region of the site assignment when the SIP trunks that are associated with the site assignment fail to include any available telephone network identifiers.

In some aspects, the techniques described herein relate to a communication server system wherein execution of the instructions further cause the communication server system to the route call data between the one or more devices associated with the active client accounts dynamically linked to the reservable PBX system identifier and the user device associated with the telephone network identifier by: converting the call data between a first protocol associated with the one or more devices associated with the active client accounts and a second protocol associated with the user device.

In some aspects, the techniques described herein relate to a communication server system wherein the one or more devices associated with the active client accounts includes a server configured to provide a web based audio/visual conferencing platform through which the call data is routed.

In some aspects, the techniques described herein relate to a method for routing call data, the method including: detecting a call event relating to a telephone network identifier; dynamically linking one or more active client accounts to a reservable PBX system identifier based on first details of the call event and second details of the one or more active client accounts; and routing the call data between one or more devices associated with the active client accounts dynamically linked to the reservable PBX system identifier and an user device associated with the telephone network identifier.

In some aspects, the techniques described herein relate to a method further wherein when the call event includes an incoming call from the telephone network identifier, the method further includes: receiving the first details of the call event as part of the incoming call; identifying the reservable PBX system identifier from the first details of the call event; retrieving a set of potential client accounts that are associated with the reservable PBX system identifier in a database; and selecting the one or more active client accounts from the set of potential client accounts.

In some aspects, the techniques described herein relate to a method further including: selecting the one or more active client accounts from the set of potential client accounts by identifying which ones of the set of potential client accounts are associated with currently active users.

In some aspects, the techniques described herein relate to a method wherein when the call event includes an outgoing call to the telephone network identifier, the method further includes: receiving the first details of the call event as part of the outgoing call; identifying the one or more active client accounts from the first details of the call event identifying a site assignment for the one or more active client accounts; and identifying the reservable PBX system identifier from a list of available telephone network identifiers based on the site assignment.

In some aspects, the techniques described herein relate to a method further including: searching all SIP trunks of the PBX system that are associated with the site assignment and a parent region of the site assignment for the list of available telephone network identifiers; selecting the reservable PBX system identifier as a first available identifier identified from the SIP trunks that are associated with the site assignment; and selecting the reservable PBX system identifier as a first available identifier identified from the SIP trunks that are associated with the parent region of the site assignment when the SIP trunks that are associated with the site assignment fail to include any available telephone network identifiers.

In some aspects, the techniques described herein relate to a method wherein routing the call data between the one or more devices associated with the active client accounts dynamically linked to the reservable PBX system identifier and the user device associated with the telephone network identifier includes: converting the call data between a first protocol associated with the one or more devices associated with the active client accounts and a second protocol associated with the user device.

In some aspects, the techniques described herein relate to a tangible machine-readable medium including instructions that, when executed by one or more processors, cause a machine to at least: detect a call event relating to a telephone network identifier; dynamically link one or more active client accounts to a reservable PBX system identifier based on first details of the call event and second details of the one or more active client accounts; and route call data between one or more devices associated with the active client accounts dynamically linked to the reservable PBX system identifier and an user device associated with the telephone network identifier.

In some aspects, the techniques described herein relate to a tangible machine-readable medium, further including instructions that, when executed by the one or more processors, cause the machine to at least: receive the first details of the call event as part of an incoming call from the telephone network identifier, the incoming call including the call event; identify the reservable PBX system identifier from the first details of the call event; retrieve a set of potential client accounts that are associated with the reservable PBX system identifier in a database; and select the one or more active client accounts from the set of potential client accounts.

In some aspects, the techniques described herein relate to a tangible machine-readable medium, further including instructions that, when executed by the one or more processors, cause the machine to at least: select the one or more active client accounts from the set of potential client accounts by identifying which ones of the set of potential client accounts are associated with currently active users.

In some aspects, the techniques described herein relate to a tangible machine-readable medium, further including instructions that, when executed by the one or more processors, cause the machine to at least: receive the first details of the call event as part of an outgoing call to the telephone network identifier, the outgoing call including the call event; identify the one or more active client accounts from the first details of the call event identify a site assignment for the one or more active client accounts; and identify the reservable PBX system identifier from a list of available telephone network identifiers based on the site assignment.

In some aspects, the techniques described herein relate to a tangible machine-readable medium, further including instructions that, when executed by the one or more processors, cause the machine to at least: search all Session Initiation Protocol (SIP) trunks that are associated with the site assignment and a parent region of the site assignment for the list of available telephone network identifiers; select the reservable PBX system identifier as a first available identifier identified from the SIP trunks that are associated with the site assignment when the SIP trunks that are associated with the site assignment fail to include any available telephone network identifiers, select the reservable PBX system identifier as a first available identifier identified from the SIP trunks that are associated with the parent region of the site assignment.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIGS. 1A and 1B depict a block diagrams of a system for routing call data, according to some embodiments.

FIG. 2 depicts a block diagram of a system for routing incoming and outgoing call data, according to some embodiments.

FIG. 3 depicts a block diagram of site and region SIP trunks according to some embodiments.

FIG. 4 depicts an example timing diagram for routing incoming call data, according to some embodiments.

FIG. 5 depicts a flow diagram of an example method for routing call data, according to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The disclosed systems and methods provide an integration between web based communication systems (e.g., those employing the Web Real-Time Communication (WebRTC) protocol) and legacy telephone infrastructure such as private branch exchange (PBX) systems that utilize session initiation protocol (SIP) trunks to connect with internal devices of the PBX system and/or external devices over the public switched telephone network (PSTN).

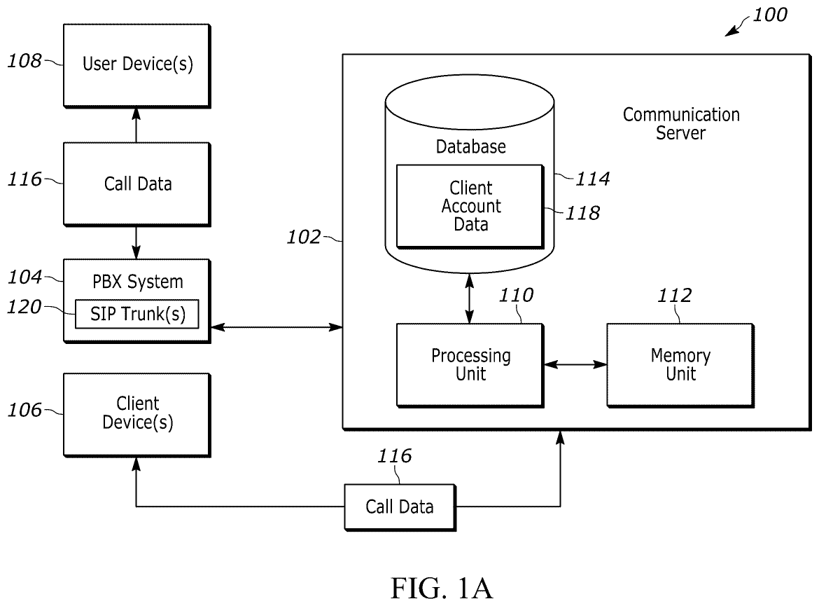

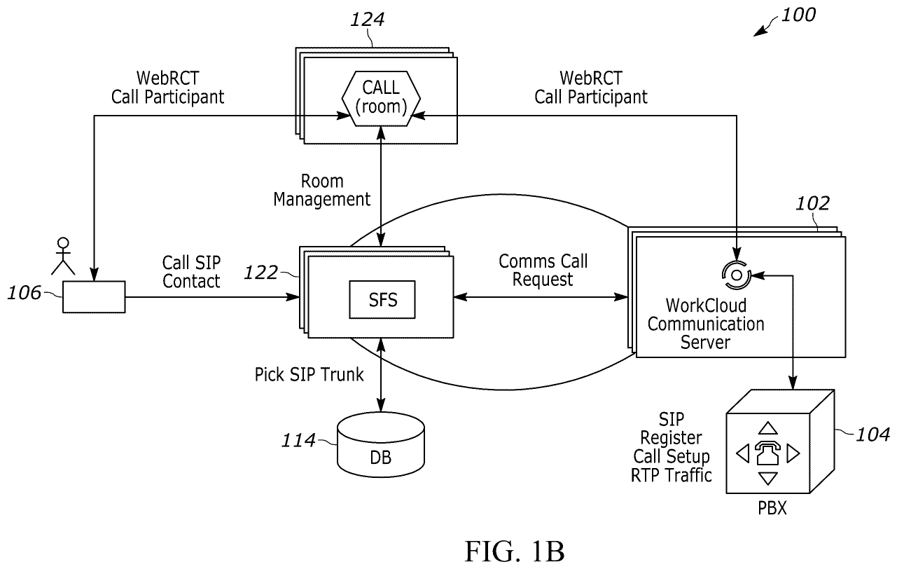

FIG. 1A depicts a system 100 for facilitating this integration. As shown in FIG. 1A, the system 100 includes a communication server 102, a PBX system 104, client device(s) 106 and user device(s) 108. The communication server 102 includes a processing unit 110, a memory unit 112 operatively coupled to the processing unit 110, and a database 114 operatively coupled to the processing unit 110. The processing unit 110 includes one or more processors, each of which may be a programmable microprocessor that executes software instructions stored in memory unit 112 to execute some or all of the functions of the communication server 102 as described herein. The processing unit 110 may include one or more graphics processing units (GPUs) and/or one or more central processing units (CPUs), for example. Alternatively, or in addition, one or more processors in processing unit 110 may be other types of processors (e.g., application-specific integrated circuits (ASICs), field-programmable gate arrays (FPGAs), etc.), and some of the functionality of communication server 102 as described herein may instead be implemented in hardware. The memory unit 112 may include one or more volatile and/or non-volatile memories. Any suitable memory type or types may be included in memory unit 112, such as read-only memory (ROM) and/or random access memory (RAM), flash memory, a solid-state drive (SSD), a hard disk drive (HDD), and so on. Collectively, the memory unit 112 may store one or more software applications, the data received/used by those applications, and the data output/generated by those applications. The database 114 may include a long term stable storage system for the communication server 102 as known in the art. The database 114 may be separate or integrated with the memory unit 112 and, in some embodiments may be separate from the communication server 102. When separate from the communication server 102, the communication server 102 may communicate with the database 114 via wired and/or wireless systems and methods known in the art.

In general operation, the communication server 102 is configured to route call data 116 between the client device(s) 106 and the user device(s) 108. This routing is facilitated by dynamically linking user accounts for the client device(s) 106 to reservable PBX identifiers of the PBX system 104 in response to a call event. The reservable PBX identifiers may include telephone numbers and/or telephone extensions used by the PBX system 104 for interconnecting with the internal and/or external ones of the user device(s) 108 as described herein.

The client device(s) 106 are configured to communicate with the communication server 102 via a web based communication protocol such as the WebRTC protocol. The client device(s) 106 may include devices such as, but not limited to, cell phones, laptops, tablets, desktop computers, etc. The client device(s) 106 may be associated with specific client accounts registered with the communication server 102. As shown in FIG. 1A, client account data 118 may be stored in the database 114 and accessed by the processing unit 110 to perform operations of the communication server 102 described herein.

The user device(s) 108 may comprise telephone devices (cell phones, landline phones, voice over IP phones, etc.) configured to communicate with the communication server 102 via the PBX system 104. For example, the user device(s) 108 may comprise external telephone devices that interface with the PBX system 104 from the public switched telephone network (PSTN) and/or internal telephone devices directly connected to the PBX system 104 (e.g., telephone devices assigned an extension by the PBX system 104 and/or that access the PSTN via the PBX system 104). In either case, the user device(s) 108 may be associated with a telephone network identifier (e.g., a telephone number, extension, etc.). As shown in FIG. 1A, the PBX system 104 may include SIP trunks 120 that the PBX system 104 uses to route call data to/from the user device(s) 108. Specifically, the SIP trunks 120 may be used to enable call routing between IP-based and traditional phone networks.

More particularly, the communication server 102 is configured to detect a call event relating to a telephone network identifier (e.g., an identifier associated with one of the user device(s) 108). The call event may include an incoming call to the client device(s) 106 from user device(s) 108 or an outgoing call from the client device(s) 106 to the user device(s) 108. The communication server 102 may be further configured to dynamically link one or more active client accounts to one of the reservable PBX system identifiers of the PBX system 104. The dynamic linking may be based on first details of the call event and second details of the one or more active client accounts. The communication server 102 may identify the active client accounts from the client account data 118. Furthermore, the reservable PBX system identifier may relate to a specific one of SIP trunks 120 of the PBX system 104 as described in more detail herein. After establishing the dynamic link, the communication server 102 may be configured to route the call data 116 between the client device(s) 106 and the user device(s) 108 based on the dynamic link. In particular, the call data 116 is routed between ones of the client device(s) 106 associated with the active client accounts that were dynamically linked to the reservable PBX system identifier and ones of the user device(s) 108 associated with the telephone network identifier to which the call event is related.

In some embodiments, the routing of the call data between the client device(s) 106 and the user devices device(s) 108 may convert the call data between a first protocol associated with the client device(s) 106 and a second protocol associated with the user device(s) 108. In particular, the communication server 102 provides a bridge that converts WebRTC signaling and media used by the client device(s) 106 into SIP or similar formats compatible with the PBX system 104.

FIG. 1B shows another embodiment of the system 100. In this embodiment, the communication server 102 utilizes server fabric services (SFS) 122 to perform some or all of the operations described herein. The SFS 122 may include additional instructions stored on the memory unit 112 and/or may include a discrete or partially discreet server system communicatively coupled to the communication server 102 via wired or wireless methods known in the art. As shown in FIG. 1B, the SFS 122 may employ the WebRTC protocol to manage web-based communications among the client device(s) 106 including with a web based audio/visual conference room 124. In some embodiments, the web based visual conference room 124 may be a part of a web based audio/visual conferencing platform managed by the SFS 122, the communication server 102, or another similar computing device coupled to the SFS 122 and/or the communication server 102.

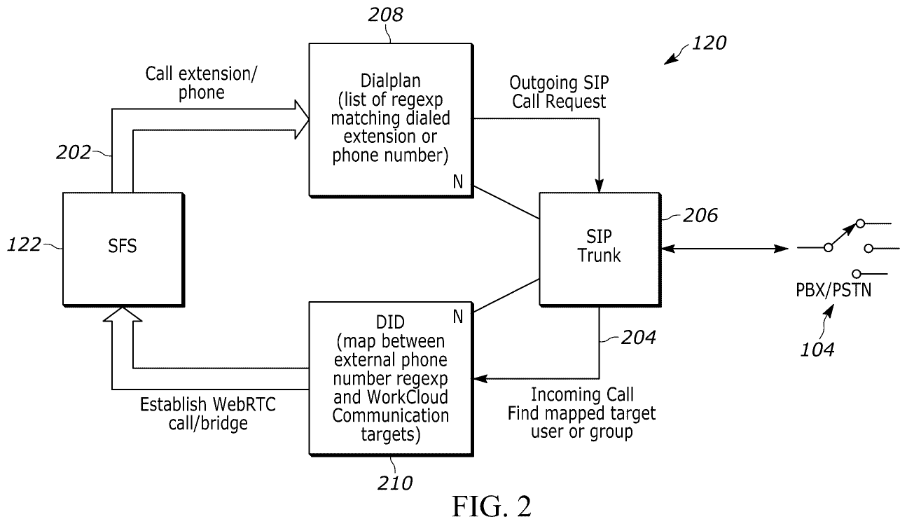

Routing of an outgoing call event 202 and an incoming call event 204 by the SFS 122 will be discussed in more detail with reference to FIG. 2. For the outgoing call event 202, the SFS 122, and in turn the communication server 102, receive the first details of the call event as part of the outgoing call event 202. For example, the SFS 122 and/or the communication server 102 receive the telephone network identifier (e.g., the telephone number, extension, etc.) for the one of the user device(s) 108 that the client device(s) 106 is attempting to call (e.g., directly via the client device, as part of the visual conference room 124, etc.). The SFS 122 and/or communication server 102 may also receive details about the client account linked to the client device(s) 106 that initiated the outgoing call event 202. As part of the data routing process, the outgoing call event 202 is linked to the reservable PBX system identifier, so that the client device(s) 106 has a temporarily assigned extension, telephone number, etc., when the outgoing call event 202 is answered by the user device(s) 108 associated with the telephone network identifier. By temporarily assigning the reservable PBX system identifier, the system 100 may be setup such that the total number of reservable PBX system identifiers is less than the total number of client device(s) 106. For example, the reservable PBX system identifier may be reassigned to different ones of the client device(s) 106 for different outgoing call events 202.

From the call event details, the SFS 122 and/or the communication server 102 may be configured to select a specific SIP trunk 206 and an associated dial plan 208 to use to connect the client device(s) 106 to the user device(s) 108 associated with the telephone network identifier. In general, selection of the specific SIP trunk 206 and an associated dial plan 208 may include the SFS 122 and/or the communication server 102 identifying a site assignment for the one or more active client accounts linked to the client device(s) 106 that initiated the outgoing call event 202 and identifying the reservable PBX system identifier from a list of available telephone network identifiers based on the site assignment. The associated dial plan 208 and other dial plans associated with other ones of the SIP trunks 120 set out a set of rules and instructions that dictate how call data is to be routed or forwarded. In some embodiments, the associated dial plan 208 may include the reservable PBX system identifier and/or the list of available telephone network identifiers.

In some embodiments, when selecting the specific SIP trunk 206 and an associated dial plan 208, the SFS 122 and/or the communication server 102 are configured to search all SIP trunks of the PBX system 104 that are associated with the site assignment and a parent region of the site assignment for the list of available telephone network identifiers. Then, the SFS 122 and/or the communication server 102 are configured to select the reservable PBX system identifier as a first available identifier identified from the SIP trunks that are associated with the site assignment and select the reservable PBX system identifier as a first available identifier identified from the SIP trunks that are associated with the parent region of the site assignment when the SIP trunks that are associated with the site assignment fail to include any available telephone network identifiers.

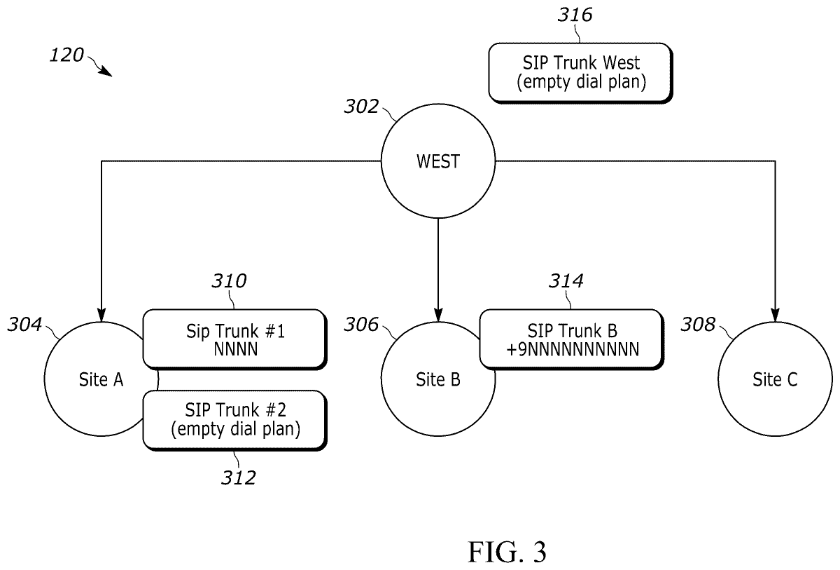

FIG. 3 shows one SIP parent region 302 of the SIP trunks 120 of the PBX system 104. The SIP parent region 302 includes sites 304, 306, and 308. Site 304 includes SIP trunks 310 and 312, site 306 includes SIP trunk 314, and the parent region 302 includes SIP trunk 316. Of the SIP trunks shown in FIG. 3, SIP trunks 312 and 316 include empty dial plans. Based on the selection process described above, the selected SIP trunk to use for routing the outgoing call event 202 depends on the site assignments and available empty dial plans. For example, where the assigned site for the client account associated with the initiating client device(s) 106 is site 304, the SFS 122 and/or the communication server 102 will search site 304 and select SIP trunk 312 for use in completing the outgoing call event 202 because the SIP trunk 312 is the first available trunk associated with the site 304 that includes an available telephone network identifier. However, where the assigned site for the client account associated with the initiating client device(s) 106 is site 306, the SFS 122 and/or the communication server 102 will search site 306 and find no available telephone network identifiers. Then, the SFS 122 and/or the communication server 102 will proceed to search the parent region 302 and/or the sites 304 and 308 to identify a SIP trunk with an available telephone network identifier (e.g., SIP trunks 312 or 316 that have empty dial plans).

With reference again to FIG. 2, for the incoming call event 204, the SFS 122, and in turn the communication server 102 are configured to receive the first details of the call event as part of the incoming call event 204 and identify the reservable PBX system identifier from the first details of the incoming call event 204. For example, the SFS 122 and/or the communication server 102 receive the telephone network identifier (e.g., the telephone number, extension, etc.) for the one of the user device(s) 108 that is initiating the incoming call event 204 and receive the reservable PBX system identifier (e.g., the telephone number or extension dialed by the one of the user device(s) 108 to initiate the incoming call event 204). In some embodiments, the reservable PBX system identifier for the incoming call event 204 may include a selection from a telephone menu system.

Specifically, the incoming call event 204 is initiated by one of the user device(s) 108 and received by one of the SIP trunks 120 with which the reservable PBX system identifier (e.g., the specific SIP trunk 206 shown in FIG. 2) is associated. Then, the SFS 122 and/or the communication server 102 are configured to retrieve a set of potential client accounts that are associated with the reservable PBX system identifier in the database 114. As shown in FIG. 3, in some embodiments, the set of potential client accounts can include direct inward dialing (DID) records assigned to the one of the SIP trunks 120 with which the reservable PBX system identifier is associated. The, SFS 122 and/or the communication server 102 may then select the one or more active client accounts from the set of potential client accounts and establish the dynamic link to route the call data from the user device(s) 108 to the associated client device(s) 106. In some embodiments, the set of potential client accounts and/or the selected one or more active client accounts may include accounts that are associated only with currently active users (e.g., users that are logged in to the system 100, are scheduled to be on the clock at the time of the incoming call event 204, etc.). Furthermore, the set of potential client accounts can be accounts associated with a specific group that is linked to the reservable PBX system identifier dialed by the user device(s) 108. For example, where the reservable PBX system identifier dialed by the user device(s) 108 is for a specific group or department of an entity that employs the system 100, the list of potential client accounts will be limited only to accounts that are assigned to that group or department in the client account data 118 contained in the database 114.

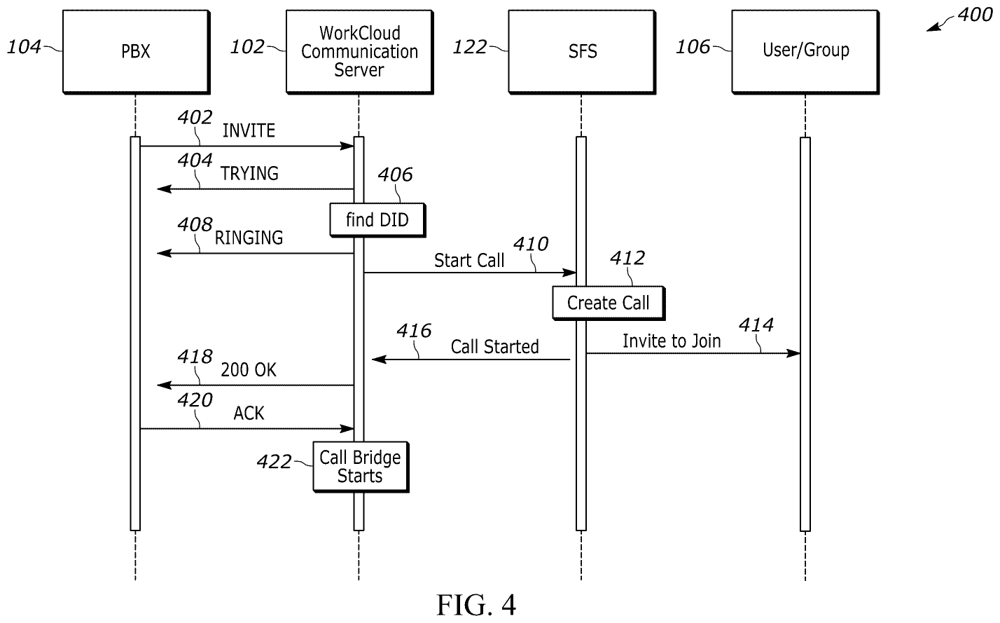

FIG. 4 depicts a timing diagram 400 for an incoming call event (e.g., incoming call event 204 of FIG. 2) received by the PBX system 104. First, the PBX system 104 transmits an invite 402 to the communication server 102, which responds with a trying notification 404. Then, the communication server 102 finds the DID record 406 (e.g., locates the one or more active client accounts) and sends a ringing notification 408 back to the PBX system 104. Then, the communication server 102 sends a start call command 410 to the SFS 122, which creates a call 412 in response. The SFS 122 then sends an invite 414 to the client device(s) 106 associated with the users or groups of users indicated by the DID record 406 and transmits a call started message 416 to the communication server 102. After receiving the call started message 416, the communication server 102 sends an OK message 418 to the PBX system 104, which responds with an acknowledgement message 420. When the communication server 102 receives the acknowledgement message 420, the communication server 102 starts a call bridge 422 that routes the call data for the incoming call event from the initiating one of the user device(s) 108 to the client device(s) 106 associated with the users or groups of users indicated by the DID record 406.

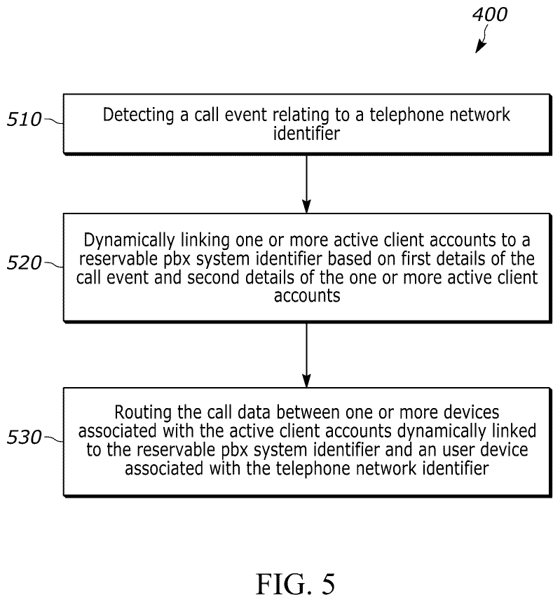

FIG. 5 is a flowchart of an example method 500 for routing call data. The method 500 may be executed by the communication server 102, the SFS 122, and/or other similar computing systems known in the art.

At block 510, the method 500 includes detecting a call event relating to a telephone network identifier.

At block 520, the method 500 includes dynamically linking one or more active client accounts to a reservable PBX system identifier based on first details of the call event and second details of the one or more active client accounts.

At block 530, the method 500 includes routing the call data between one or more devices associated with the active client accounts dynamically linked to the reservable PBX system identifier and an user device associated with the telephone network identifier. In some embodiments, routing the call data includes converting the call data between a first protocol associated with the one or more devices associated with the active client accounts and a second protocol associated with the user device.

When the call event comprises an incoming call from the telephone network identifier, the method 500 may include receiving the first details of the call event as part of the incoming call; identifying the reservable PBX system identifier from the first details of the call event; retrieving a set of potential client accounts that are associated with the reservable PBX system identifier in a database; and selecting the one or more active client accounts from the set of potential client accounts. Selecting the one or more active client accounts from the set of potential client accounts may include identifying which ones of the set of potential client accounts are associated with currently active users.

When the call event comprises an outgoing call to the telephone network identifier, the method 500 may include receiving the first details of the call event as part of the outgoing call; identifying the one or more active client accounts from the first details of the call event; identifying a site assignment for the one or more active client accounts; and identifying the reservable PBX system identifier from a list of available telephone network identifiers based on the site assignment. In some embodiments, the method 500 may include searching all SIP trunks of the PBX system that are associated with the site assignment and a parent region of the site assignment for the list of available telephone network identifiers; selecting the reservable PBX system identifier as a first available identifier identified from the SIP trunks that are associated with the site assignment; and selecting the reservable PBX system identifier as a first available identifier identified from the SIP trunks that are associated with the parent region of the site assignment when the SIP trunks that are associated with the site assignment fail to include any available telephone network identifiers.

It is understood that the blocks of the method 500 need not occur strictly in the order shown.

Although the systems, methods, devices, and components thereof, have been described in terms of exemplary embodiments, they are not limited thereto. The detailed description is to be construed as exemplary only and does not describe every possible embodiment of the invention because describing every possible embodiment would be impractical, if not impossible. Numerous alternative embodiments could be implemented, using either current technology or technology developed after the filing date of this patent that would still fall within the scope of the claims defining the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A communication server system comprising:
one or more processors; and
one or more non-transitory, computer-readable media storing instructions that, when executed by the one or more processors, cause the communication server system to:
detect a call event relating to a telephone network identifier;
dynamically link one or more active client accounts to a reservable private branch exchange (PBX) system identifier based on first details of the call event and second details of the one or more active client accounts, the PBX system employing a session initiation protocol (SIP); and
route call data between one or more devices associated with the active client accounts dynamically linked to the reservable PBX system identifier and a user device associated with the telephone network identifier.

2. The communication server system of claim 1 wherein when the call event comprises an incoming call from the telephone network identifier, execution of the instructions further cause the communication server system to:
receive the first details of the call event as part of the incoming call;
identify the reservable PBX system identifier from the first details of the call event;
retrieve a set of potential client accounts that are associated with the reservable PBX system identifier in a database; and
select the one or more active client accounts from the set of potential client accounts.

3. The communication server system of claim 2 wherein execution of the instructions further cause the communication server system to:
select the one or more active client accounts from the set of potential client accounts by identifying which ones of the set of potential client accounts are associated with currently active users.

4. The communication server system of claim 2 wherein the first details of the call event that identify the reservable PBX system identifier include a telephone extension number.

5. The communication server system of claim 2 wherein the first details of the call event that identify the reservable PBX system identifier include a selection from a telephone menu system.

6. The communication server system of claim 1 wherein when the call event comprises an outgoing call to the telephone network identifier, execution of the instructions further cause the communication server system to:
receive the first details of the call event as part of the outgoing call;
identify the one or more active client accounts from the first details of the call event;
identify a site assignment for the one or more active client accounts; and
identify the reservable PBX system identifier from a list of available telephone network identifiers based on the site assignment.

7. The communication server system of claim 6 wherein execution of the instructions further cause the communication server system to:
search all SIP trunks of the PBX system that are associated with the site assignment and a parent region of the site assignment for the list of available telephone network identifiers;
select the reservable PBX system identifier as a first available identifier identified from the SIP trunks that are associated with the site assignment; and
select the reservable PBX system identifier as a first available identifier identified from the SIP trunks that are associated with the parent region of the site assignment when the SIP trunks that are associated with the site assignment fail to include any available telephone network identifiers.

8. The communication server system of claim 1 wherein execution of the instructions further cause the communication server system to route the call data between the one or more devices associated with the active client accounts dynamically linked to the reservable PBX system identifier and the user device associated with the telephone network identifier by:
converting the call data between a first protocol associated with the one or more devices associated with the active client accounts and a second protocol associated with the user device.

9. The communication server system of claim 1 wherein the one or more devices associated with the active client accounts includes a server configured to provide a web based audio/visual conferencing platform through which the call data is routed.

10. A method for routing call data, the method comprising:
detecting a call event relating to a telephone network identifier;
dynamically linking one or more active client accounts to a reservable PBX system identifier based on first details of the call event and second details of the one or more active client accounts; and
routing the call data between one or more devices associated with the active client accounts dynamically linked to the reservable PBX system identifier and an user device associated with the telephone network identifier.

11. The method of claim 10 further wherein when the call event comprises an incoming call from the telephone network identifier, the method further comprises:
receiving the first details of the call event as part of the incoming call;
identifying the reservable PBX system identifier from the first details of the call event;
retrieving a set of potential client accounts that are associated with the reservable PBX system identifier in a database; and
selecting the one or more active client accounts from the set of potential client accounts.

12. The method of claim 11 further comprising:
selecting the one or more active client accounts from the set of potential client accounts by identifying which ones of the set of potential client accounts are associated with currently active users.

13. The method of claim 10 wherein when the call event comprises an outgoing call to the telephone network identifier, the method further comprises:
receiving the first details of the call event as part of the outgoing call;
identifying the one or more active client accounts from the first details of the call event;
identifying a site assignment for the one or more active client accounts; and
identifying the reservable PBX system identifier from a list of available telephone network identifiers based on the site assignment.

14. The method of claim 13 further comprising:
searching all SIP trunks of the PBX system that are associated with the site assignment and a parent region of the site assignment for the list of available telephone network identifiers;
selecting the reservable PBX system identifier as a first available identifier identified from the SIP trunks that are associated with the site assignment; and
selecting the reservable PBX system identifier as a first available identifier identified from the SIP trunks that are associated with the parent region of the site assignment when the SIP trunks that are associated with the site assignment fail to include any available telephone network identifiers.

15. The method of claim 10 wherein routing the call data between the one or more devices associated with the active client accounts dynamically linked to the reservable PBX system identifier and the user device associated with the telephone network identifier comprises:
converting the call data between a first protocol associated with the one or more devices associated with the active client accounts and a second protocol associated with the user device.

16. A tangible machine-readable medium comprising instructions that, when executed by one or more processors, cause a machine to at least:
detect a call event relating to a telephone network identifier;
dynamically link one or more active client accounts to a reservable PBX system identifier based on first details of the call event and second details of the one or more active client accounts; and
route call data between one or more devices associated with the active client accounts dynamically linked to the reservable PBX system identifier and an user device associated with the telephone network identifier.

17. The tangible machine-readable medium of claim 16, further comprising instructions that, when executed by the one or more processors, cause the machine to at least:
receive the first details of the call event as part of an incoming call from the telephone network identifier, the incoming call comprising the call event;
identify the reservable PBX system identifier from the first details of the call event;
retrieve a set of potential client accounts that are associated with the reservable PBX system identifier in a database; and
select the one or more active client accounts from the set of potential client accounts.

18. The tangible machine-readable medium of claim 17, further comprising instructions that, when executed by the one or more processors, cause the machine to at least:
select the one or more active client accounts from the set of potential client accounts by identifying which ones of the set of potential client accounts are associated with currently active users.

19. The tangible machine-readable medium of claim 16, further comprising instructions that, when executed by the one or more processors, cause the machine to at least:
receive the first details of the call event as part of an outgoing call to the telephone network identifier, the outgoing call comprising the call event;
identify the one or more active client accounts from the first details of the call event;
identify a site assignment for the one or more active client accounts; and
identify the reservable PBX system identifier from a list of available telephone network identifiers based on the site assignment.

20. The tangible machine-readable medium of claim 19, further comprising instructions that, when executed by the one or more processors, cause the machine to at least:
search all Session Initiation Protocol (SIP) trunks that are associated with the site assignment and a parent region of the site assignment for the list of available telephone network identifiers;
select the reservable PBX system identifier as a first available identifier identified from the SIP trunks that are associated with the site assignment;
when the SIP trunks that are associated with the site assignment fail to include any available telephone network identifiers, select the reservable PBX system identifier as a first available identifier identified from the SIP trunks that are associated with the parent region of the site assignment.
